(19) United States
(12) Patent Application Publication
(10) Pub. No.: US 2026/0135706 A1
(43) Pub. Date: May 14, 2026

(54) WHITE-BOX CRYPTOGRAPHIC KEYS

(71) Applicant: BANKS AND ACQUIRERS INTERNATIONAL HOLDING, SURESNES (FR)

(72) Inventor: Vincent GIRAUD, PARIS (FR)

(21) Appl. No.: 19/121,500

(22) PCT Filed: Oct. 17, 2023
(86) PCT No.: PCT/EP2023/078872

§ 371 Date: May 12, 2025

(30) Foreign Application Priority Data
Oct. 17, 2022 (FR) FR2210700

(51) Int. Cl. H04L 9/30

(52) U.S. Cl. CPC H04L 9/304; H04L 2209/16

(57) ABSTRACT

A method for generating a cryptographic key, which is executed by a computer processor, wherein steps of generating matrices in accordance with a McEliece cryptosystem are carried out. The computer processor then further executes at least two of the following three combination steps: combining one random encoding matrix with the merged permutation, coding and transformation matrix to form an encoded permutation, coding and transformation matrix; combining another random encoding matrix with the permutation cancellation matrix to form an encoded permutation cancellation matrix; and combining another random encoding matrix with the transformation cancellation matrix to form an encoded transformation cancellation matrix.

### FIELD OF THE INVENTION

The invention relates to white-box cryptography.

### BACKGROUND

White-box cryptography is a study subject based on the postulate that an attacker, who tries to identify secret, encrypted data, that can be decrypted using an encryption algorithm, has full access to the algorithm execution platform and to the software implementation of this algorithm in the platform: the binary code is thus completely visible, it can be modified, and the attacker can also do whatever they wish regarding the software execution by means of the various systems of the platform such as the memory, calls to the processors, etc. The most traditional example is that of an attacker who has access to a smartphone belonging to a third party, in which a software application of the smartphone encrypts or decrypts secret data using an encryption key and a cryptographic algorithm, for example of the “AES” (Advanced Encryption Standard) type. The attacker has complete control over the smartphone and the algorithm, and can thus try to read the corresponding binary code, modify it, execute it specifically, with the final objective, knowing the type of algorithm used, of identifying the encryption key, decrypting the secret data, and/or modifying these data.

To prevent this attacker from accessing the secret data and to protect the integrity of the encryption in this white-box context, a method consisting in encoding elementary operations of the encryption (or decryption) algorithm is already known in the state of the art. In fact, an elementary operation, resulting from the combination between a known type of algorithm and a specific encryption key, is generally implemented as a truth table indicating the possible results of the operation depending on the input data. An encoding operation therefore consists in applying a random transformation to an elementary operation in order to make this operation illegible. To encode an operation, elements of the truth table can be substituted, by combining the initial table with a random substitution table, in order to obtain an “obfuscated” or “merged” table. Alternatively, a linear transformation can be applied to the operation by combining a vector representing the output data, or a matrix corresponding to the operation, with another matrix, called encoding matrix, the latter also being random. An encoding can also be a combination of one or more substitutions and one or more encoding matrices. Other encoding types are possible. In addition, each elementary operation succeeding an encoded elementary operation is itself combined with an “inverse” encoding, or decoding, corresponding to the inverse of the previous encoding. This is for example the inverse substitution table or the inverse matrix corresponding to the previous encoding, so that the algorithm planned initially is not modified by the successive encodings. In all cases, only the truth tables resulting from these encoding operations merged with the elementary operations, in other words the “obfuscated” or “merged” tables are stored in the software memory implementing the algorithm. Consequently, since the attacker can only access the obfuscated tables, they cannot identify which elementary operation is associated with each table and therefore cannot determine the cryptographic key used and decrypt the secret data.

These encodings, used to encode an encryption (and/or decryption) algorithm in a non-secure execution platform, for example in a smartphone, are said to be “internal”, since they can make the encryption key used in the white box formed by the algorithm implemented illegible.

However, this white box generally communicates firstly with a remote server and secondly with a third-party application located on the same platform. For example, a server frequently encrypts data and sends the encrypted data to the smartphone, then the white box, in other words the decryption algorithm executed by the smartphone, is used to decrypt the data before these decrypted data are sent, in the same smartphone, to a third-party “final” application, intended to use the decrypted data. However, the final applications are developed by third-party companies, independently of the white boxes. These companies therefore purchase white boxes sold as software libraries containing the encryption and decryption algorithm, and an API (Application Programming Interface) to control the algorithm and use the data output from this algorithm in the final application developed. In this context, the “internal” encodings in the white box do not prevent the decrypted data from circulating, unencoded, between the white box and the final application. Similarly, even if the cryptographic key used is now very difficult to identify in the white box, due to the internal encodings installed in this white box, the attacker can try to port the code, in other words to export the entire code from the white box to another peripheral to process it therein without having to identify the key.

Consequently, it is known in the state of the art to implement, in addition to these internal encodings, “external” encodings placed at the ends of the complete communication channel between transmission of the data and their use. For example, firstly in the remote server, a first “external” encoding is applied to the last truth table of the server encryption algorithm, whether in the form of a substitution table, an encoding matrix or another form of random encoding, so that the data to be sent to the smartphone are not only encrypted as planned, but also encoded before being sent to the smartphone. Then, at the white-box input, the inverse encoding of the external encoding is applied to the first truth table of the decryption algorithm, before the data are processed using the decryption algorithm of the white box and its internal encodings. The inverse encoding, which is the decoding of the first external encoding, is therefore part of the white box. Then, a new random encoding is carried out at the white-box output, by applying this new encoding to the last truth table of the white box. Once again, this second encoding is part of the white box. At output, the data are therefore decrypted, but once again encoded, this time using this new random encoding, before being sent to the final third-party application intended to use them. Lastly, in this third-party application, the external encoding corresponding to the inverse of the encoding applied at end of white box is used to decode the data in the application before they are used by the application.

Using these external encodings placed outside the white box, even when the data are decrypted, they do not circulate “unencoded” outside the white box, they remain encoded, therefore protected from the manipulations of an attacker who would want to intercept them. In addition, the attack consisting in porting the entire code from the white box to another peripheral fails, since in this context, the code of the white box comprises an encoding at its input and an encoding at its output. Without the corresponding inverse encodings, which are located remotely (in the server and in the final application), it is impossible to find the unencoded data. In addition, added to the internal encodings, these external encodings associated with encodings at white-box output and input, make it even more difficult to identify the encryption key of the white box.

Note that all these encodings, both internal and external, are random, in other words they call transformations, substitutions or other manipulations unknown to everyone, so that no attacker can find them.

However, this system still comprises at least two disadvantages.

Firstly, although the white box of the user's end terminal is encoded, this is generally not the case of the cryptographic algorithm located on the remote server. In fact, unlike the user's end terminal, that is mobile and easily accessible, the server is assumed to be a secure environment. Consequently, to avoid increasing its processing times, the encryption and decryption algorithm of the server does not generally include internal encoding, but only encoding at output. Thus, if this algorithm was to leak, and in particular if the encoding at output is not sufficiently protected, it would then become possible for an attacker to identify the elementary operations and therefore the encryption and decryption keys. However, in a context of symmetric encryption such as AES, the same key is used to encrypt and decrypt the data. The user's key, encoded in the white box on the user's terminal, would therefore be identified as causing the leak of the algorithm not encoded on the remote server.

In addition, the current algorithms used in white box are not considered to be sufficiently resistant to future quantum attacks.

### SUMMARY

The invention aims in particular to improve the integrity of the cryptographic keys of the white-box cryptographic methods.

Another objective is to anticipate the future quantum attacks.

Thus, the invention relates to a method for generating a cryptographic key, executed by computer processing means, and in which the following steps are carried out:
generating a permutation matrix, a coding matrix and a linear transformation matrix, the three matrices being in accordance with a McEliece cryptosystem;
generating an inverse permutation cancellation matrix of the permutation matrix, an inverse coding cancellation matrix of the coding matrix, and an inverse transformation cancellation matrix of the linear transformation matrix, the three cancellation matrices being in accordance with the McEliece cryptosystem;
combining the permutation matrix with the coding matrix and with the linear transformation matrix, to form a merged permutation, coding and transformation matrix in accordance with the McEliece cryptosystem,
the computer processing means executing a step of generating at least two random encoding matrices, the computer processing means executing at least two of the following three combinations steps:
combining one of the random encoding matrices with the merged permutation, coding and transformation matrix to form an encoded permutation, coding and transformation matrix,
combining one of the other random encoding matrices with the permutation cancellation matrix to form an encoded permutation cancellation matrix,
combining one of the other random encoding matrices with the transformation cancellation matrix to form an encoded transformation cancellation matrix.

Thus, the encoded permutation, coding and transformation matrix masks the public key in accordance with the McEliece cryptosystem, which is formed initially from the merged permutation, coding and transformation matrix. The encoded permutation cancellation matrix and the encoded transformation cancellation matrix each masks a private key of the McEliece cryptosystem, respectively the permutation cancellation matrix and the transformation cancellation matrix.

Generating at least two of these encodings protects the integrity of the data to be encrypted or decrypted. In fact, even if the merged permutation, coding and transformation matrix is not encoded and is made accessible to an attacker, and even if the attacker accesses the coding matrix, this attacker is unable to deduce the permutation cancellation matrix or the transformation cancellation matrix since the latter are both encoded. Alternatively, if the merged permutation, coding and transformation matrix is encoded, but one of the two cancellation matrices is not encoded and is made accessible to an attacker, the latter is unable to deduce the other cancellation matrix. Thus, with at least two encodings out of the three, and even if the coding cancellation matrix is accessible, an attacker is unable to simultaneously obtain the three cancellation matrices, in other words all the private keys. This protects in particular the cryptographic keys in the event of a leak on the server, since the latter only includes the public key, in other words the merged permutation, coding and transformation matrix. This therefore improves the protection of the white-box cryptographic keys.

In addition, these permutation, coding and transformation operations in accordance with the McEliece cryptosystem are known to be resistant to the future quantum attacks. This method for generating keys can therefore be used to obtain a cryptosystem that is resistant to the future quantum attacks while protecting the integrity of the cryptographic keys, even in the event of a leak on the server.

Advantageously, the computer processing means execute the three combination steps.

Thus, the encryption security is increased, by encoding the three matrices instead of two of them. In other words, the public key of the McEliece cryptosystem, corresponding to the merged permutation, coding and transformation matrix, is masked since this matrix is encoded, like the two private keys, in other words the permutation cancellation matrix and the transformation cancellation matrix, which are encoded. Even if the attacker should succeed in decoding one of these three encoded matrices, they would be unable to obtain all the private keys. An attacker would then have to decode two of the three encoded matrices to obtain all the private keys.

Preferably, for each random encoding matrix generated, the processing means execute a step of determining a corresponding inverse encoding matrix of said random encoding matrix, so that a data series encoded by said random encoding matrix is decoded by the corresponding inverse encoding matrix and vice versa.

Thus, the encryption algorithm is not disturbed by the encodings since inverse encodings are planned. Like the encodings, the inverse encodings mask operations or data series. Intercepting an encoded data series before it is decoded by a corresponding inverse encoding matrix does not allow the attacker to identify the data series or the encoded operation concerning the data series.

Advantageously, the computer processing means execute at least two of the following three integration steps:
integrating, in an application for encryption server, the encoded permutation, coding and transformation matrix;
integrating, in an application for decryption terminal, the encoded permutation cancellation matrix;
integrating, in the application for terminal, the encoded transformation cancellation matrix.

Thus, once generated, the three masked keys, formed by the encoded matrices, are integrated in their respective positions. This is the server for the masked public key formed by the encoded permutation, coding and transformation matrix. This is the white box of the terminal for the masked private key formed by the encoded permutation cancellation matrix and the final application of the terminal for the masked private key formed by the encoded transformation cancellation matrix.

Advantageously, the means further execute at least two out of the following three integration steps:
integrating, in an application for content server, the corresponding inverse encoding matrix of the encoding matrix that has been combined with the merged permutation, coding and transformation matrix, so that a data series encoded by this inverse encoding matrix on a content server is decoded by the encoded permutation, coding and transformation matrix on an encryption server;
integrating, in the application for terminal, the corresponding inverse encoding matrix of the encoding matrix that has been combined with the permutation cancellation matrix, so that a data series encoded by this inverse encoding matrix on the encryption server is decoded by the encoded permutation cancellation matrix on a decryption terminal;
integrating, in the application for terminal, the corresponding inverse encoding matrix of the encoding matrix that has been combined with the transformation cancellation matrix, so that a data series encoded by the encoded transformation cancellation matrix is decoded by the inverse encoding matrix.

Thus, the corresponding inverse encodings are placed “opposite” the integrated masked keys, in order to decode the encoded data by masking these keys. If the public key is formed by the merged permutation, coding and transformation matrix, having encoded it and placing beforehand an inverse encoding matrix divides the server, at least in terms of software, between a content server, in which the data series is encoded by the inverse encoding matrix, and an encryption server, comprising the merged encoded permutation, coding and transformation matrix. Thus, an attacker intercepting the content intended to be encrypted would find a data series that has already been encoded before it starts to be encrypted by the public key, thereby once again increasing the security. In addition, the content server and the encryption server can therefore be separated and placed in different locations.

The invention also provides for a method for encrypting data, in which, to encrypt a data series, computer processing means execute the following steps:
after a merged transformation, coding and permutation matrix, in accordance with a McEliece cryptosystem, has been combined with an encoding matrix to form an encoded coding, permutation and transformation matrix, applying the encoded coding, permutation and transformation matrix to the data series, in order to form a coded, permuted and transformed data series;
deliberately adding one or more errors, in accordance with the McEliece cryptosystem, to the coded permuted and transformed data series, in order to form an encrypted data series.

Thus, the encryption method includes encrypting the McEliece cryptosystem using a public key, masked by an encoding matrix, then adding errors in accordance with the McEliece cryptosystem. The encryption method therefore takes advantage of McEliece and of the encodings to encrypt a data series intended to be then decrypted in white box. Since the public key corresponds to a combination of private keys, even if it was unmasked, an attacker would be unable to find all the private keys, in other words the individual coding, permutation and transformation matrices, since they are merged in this encryption method.

Advantageously, beforehand, the computer processing means apply to the data series a preliminary inverse encoding matrix of the encoding matrix to form an encoded data series, so that the encoded data series is then decoded by the encoded coding, permutation and transformation matrix at the same time as it is coded, permuted and transformed by this encoded coding and permutation matrix.

Thus, the aim is to encode the data, in particular on a content server, even before the data series is encrypted in accordance with the McEliece cryptosystem on an encryption server. The encryption security is therefore increased.

Advantageously, in addition, the computer processing means further execute a step of applying a second encoding matrix to the encrypted data series, to form an encrypted and encoded data series.

Thus, at encryption output, the encrypted data series is also encoded. This encoding corresponds to the inverse encoding to which the data series will be subjected in the decryption method, inverse encoding being used to mask a private key. Consequently, the encoding applied during this encryption method can be used to prepare the decryption while further improving the data integrity.

The invention also provides for a data decryption method, characterised in that, to decrypt an encrypted data series, a permutation cancellation matrix, in accordance with a McEliece cryptosystem, having been combined with an inverse encoding cancellation matrix of an encoding matrix, previously applied during an encryption operation, to form an encoded permutation cancellation matrix, the processing means execute a step of applying to the encrypted data series the encoded permutation cancellation matrix to form a restructured data series with cancelled encoding.

Thus, one of the private keys of the McEliece cryptosystem, formed by the permutation cancellation matrix, is in this case masked by the encoding, forming the encoded permutation cancellation matrix. The encoding used to mask this key is the inverse encoding of that used at encryption output. The data received are therefore encrypted but also encoded, to be decoded at white-box input while being restructured. Masking the private key therefore contributes to decoding these data at the same time.

Preferably, the means execute a step of removing errors, in accordance with the McEliece cryptosystem, from the restructured data series with cancelled encoding, in order to form a corrected, restructured data series with cancelled encoding.

Thus, the remainder of the decryption corresponds to an error-removal step of the McEliece cryptosystem.

Advantageously, the means execute the following steps:
applying a decoding matrix, in accordance with the McEliece cryptosystem aimed at decoding data previously coded during an encryption operation, to the corrected, restructured data series with cancelled encoding, in order to form a corrected and decoded restructured data series with cancelled encoding;
a transformation cancellation matrix, in accordance with a McEliece cryptosystem, having been combined with an encoding matrix to form an encoded transformation cancellation matrix, applying to the corrected and decoded restructured data series, with cancelled encoding, the encoded transformation cancellation matrix, to form a decrypted and encoded data series.

Thus, two other private keys of the McEliece cryptosystem, formed in this case by the decoding matrix to decode the coded data and by the transformation cancellation matrix, are also masked, due to the encodings. The private keys of the McEliece cryptosystem, present in white box to decrypt the data, are therefore protected. In addition, encoding the transformation cancellation matrix simultaneously encodes the decrypted data. Thus, the data are decrypted in the white box in accordance with the McEliece cryptosystem and simultaneously encoded at white-box output, which improves their security.

Preferably, the means execute a step of applying, to the decrypted and encoded data series, an encoding cancellation matrix, inverse of the encoding matrix used to form the encoded transformation cancellation matrix, in order to form a decrypted data series.

Thus, in the final application, the decrypted and encoded data are decoded so that they can be used.

The invention also provides for a computer program comprising instructions which, when the program is executed by a computer, instruct the computer to implement the steps of the method described above.

The invention also provides for a computer-readable storage medium comprising instructions which, when they are executed by a computer, instruct the computer to implement the steps of the method described above.

The invention also provides for a cryptographic key generation server, comprising computer processing means adapted to execute a method described above.

The invention also provides for an encryption server, comprising computer processing means adapted to execute an encryption method described above to encrypt a data series.

The invention also provides for a communication terminal, comprising computer processing means adapted to execute a decryption method described above to decrypt a data series.

The invention also provides for a cryptosystem comprising at least one server described above and at least one terminal described above.

### BRIEF DESCRIPTION OF THE FIGURES

The invention will be better understood on reading the following description, given solely by way of example and with reference to the accompanying drawings in which:

FIG. 1 is a diagram of the elements forming a cryptosystem according to one embodiment of the invention;

FIG. 2 is a diagram of the operations carried out in the cryptosystem of FIG. 1;

FIG. 3 is a flowchart of a key generation and encoding method of the invention;

FIG. 4 is a flowchart of an encryption method of the invention;

FIG. 5 is a flowchart of a decryption method of the invention.

### DETAILED DESCRIPTION

### Definitions

Here and throughout the description, we will refer to a data series to be encrypted. This data series corresponds in particular to a vector or a segment of binary numbers whose content and order form a message. Thus, the data series 3 of the preferred embodiment described below corresponds to banking data, structured into a series of binary data whose order produces a meaning for computer means. It may, however, concern any type of data, provided that they form a message consisting of a data series whose meaning is defined by its structure, which makes it possible to encrypt the message by adding redundancies at specific positions of the series and/or by permuting the data series. Obviously, the invention can be applied to data other than banking data.

“Coding”, or “to code” designates an operation carried out to replace one or more data items in the data series by other data according to predetermined rules, for example, one series of bits by another series of bits. The coding rules are specific to the type of coding used, for example those of the “Goppa” codes. For convenience, we will continue to use the term “coding” to designate a coding operation that has been combined with one or more other operations to form a merged operation, since even if this coding operation can then no longer be distinguished from the others in the executable code, the operation is carried out.

“Encoding”, or “to encode” designates the application, to an operation, of another so-called encoding operation, aimed at masking the targeted operation. The aim is in particular to combine the planned operation with a so-called encoding matrix, in order to prevent an attacker from understanding the operation that was initially planned. In particular, when a matrix corresponding to a planned operation is combined with an encoding matrix, only the resulting so-called “merged” or “obfuscated” matrix of this encoding is stored in the memory, so that it is impossible for an attacker to distinguish, in the executable code, between the initial operation and the encoding, the two forming a single matrix. Instead of an encoding matrix, other types of encoding can be used, such as substitution tables to replace truth tables in the software memory, thus masking the planned operation by the truth table. Unless otherwise specified, the remainder of the description will apply to any type of encoding satisfying the need to mask an operation or a data series. For convenience, we will continue to use the term “encoding” to designate an encoding operation that has been combined with one or more other operations to form a merged operation, or a “masked” operation, since even if this encoding operation can then no longer be distinguished from the others in the executable code, the operation is carried out. Although an encoding applies to an operation and not to data, we can speak of “encoded data” when a data series is transformed by an operation that is itself encoded.

The term “decoding” and the verb “to decode” therefore have two possible meanings depending on what they refer to. One corresponds to decoding a series of data that have been previously encoded by a coding operation. The aim is therefore to decode “coded” data, in other words to restore the data series as it was before it was coded, using the coded rules provided for this purpose. The other meaning concerns the decoding of “encoded” data or the decoding of an “encoded” operation. The aim is in particular to use the inverse matrix of the encoding matrix used previously, to restore the data series or the operation planned initially. The meaning of the term “decoding” out of these two possibilities will be specified or will appear clearly in the remainder of the description depending on the context.

“Key” will designate a cryptographic key used, when combined with a predetermined type of algorithm, to encrypt or decrypt data. In the context of asymmetric cryptography, a public key can be accessible to the public, whereas a private key is intended to remain secret, possibly known by its holder alone. For a given cryptosystem, a public key encrypts what is decrypted by a private key, and these keys are different from each other.

If several private keys or several public keys are required, each one of these keys is a public key or respectively a private key. However, for convenience, all public keys or private keys can be designated as forming a single private key or public key.

Lastly, it must be understood that if a matrix is accessible, in other words it can be read, its inverse matrix, if any, can be easily calculated. In other words, knowing an invertible matrix A also means knowing the matrix A-1, inverse matrix of the matrix A.

We will now give a reminder of some of the elements of a cryptosystem known in the state of the art, the McEliece cryptosystem.

### The McEliece Cryptosystem

The McEliece cryptosystem is an asymmetric encryption diagram, invented in 1978 by Robert McEliece and based in particular on the theory of codes, using “Goppa codes”. Only the notions of this cryptosystem useful for the description of this embodiment will be outlined below.

When generating keys in accordance with the McEliece cryptosystem, computer processing means generate matrices named by convention G, P and S. The matrix G is used to code a data series to be encrypted, using Goppa codes. The matrix P is used to permute the data of a data series, in other words to modify the order of the data in the data series, for example the order of bits in a bit series. The structure of the data series to be encrypted is therefore modified by P. The matrix S is a random matrix whose specifications are specific to the McEliece system and which corresponds to a linear application using neither Goppa code, nor specific permutation.

The processing means also generate the inverse matrices of these matrices S, G and P, in other words the matrices S⁻¹, G⁻¹ and P⁻¹. It can be considered that the matrices, S, G, and P, and possibly their inverse matrices, form three or six keys (depending on whether we consider a private matrix and its inverse to be one or two keys) of the McEliece cryptosystem. Alternatively, we may consider that these matrices form a single private key including all these matrices independently of one another. By convention, this private key is then named (S, G, P). Both considerations are equivalent and valid. The processing means also generate the matrix SGP by multiplying the three matrices S, G and P together. The matrix SGP can be considered to be a multiplication or a combination of the matrices S, G and P, forming a merged matrix SGP making it impossible to distinguish between the matrices S, G and P independently of one another. This matrix SGP forms the public key of the McEliece cryptosystem. This key is not necessarily intended to be disclosed, but it can be made more easily accessible to a third-party server wanting to encrypt data, while the private keys S, G and P must remain secret.

In short, after generating the keys, we obtain a private key (S, G, P) (or equivalently private keys S, S⁻¹, G, G⁻¹, P, P⁻¹) and a public key SGP. These keys are then combined with encryption and decryption algorithms described below.

We will now mention the encryption steps according to the McEliece cryptosystem.

The public key is used to encrypt the data series. In other words, the computer processing means apply the matrix SGP to the data series, as a multiplication. The multiplication rules being adapted to the type of data in the data series, it may consist of an operation in the binary Galois body for binary data, or in the body of reals or other types of application, since the McEliece cryptosystem does not depend on a type of multiplication. Multiplying this data series by the matrix SGP amounts to, simultaneously, coding the series by the operations of the matrix G masked in the matrix SGP and permuting the data of the series by the operations of the matrix P masked in this merged matrix SGP, while applying the linear transformation operations of the matrix S, also masked in this matrix SGP.

Lastly, the processing means deliberately add one or more errors to the coded and permuted data series. This coded, permuted and incorrect data series is thus the data series encrypted in accordance with the McEliece cryptosystem.

This encryption generally takes place on a server intended to encrypt data before sending them to a remote peripheral, for example to a communication terminal such as a smartphone. The computer processing means mentioned are therefore those of this server.

We will now mention the decryption steps according to the McEliece cryptosystem, which are carried out on the peripheral receiving the encrypted data.

To decrypt the encrypted data series received by the peripheral, the specific computer processing means of the latter use the private key (S, G, P). In concrete terms, the encrypted data series is multiplied by the matrix (or private key) P⁻¹, in order to permute the data of the series inversely compared with the permutation generated by the key SGP. The original permutation being inverted, the processing means restore the original structure of the data series. Since this original structure has been restored, the means can correct this data series, in other words identify and remove the errors deliberated added during the encryption. This correction is carried out according to any known fast error-correction algorithm. The data series which arrived encrypted has now been restored to its initial structure and has been “corrected”. The matrix G⁻¹, then the matrix S⁻¹ are applied in turn, the matrix G⁻¹ being used to decode the data series encoded using the coding the matrix G during the encryption, the matrix S⁻¹ being used to cancel the linear transformation of the matrix S during the encryption. The data series, which arrived encrypted on the peripheral, is therefore permuted inversely, corrected, and now decoded. It is therefore decrypted and corresponds to the data series as it was, “unencoded” before the encryption. Note that in this case, the term “decoded” designates the inverse of a “coding” operation.

Obviously, the encryption operations can be carried out on the terminal side and the decryption operations on the server side if the public key SGP is located on the terminal side and the private key (S, G, P) on the server side.

Note that one of the advantages of asymmetric encryption, as allowed by the McEliece cryptosystem, is that the public key, in this case the matrix SGP, can be accessible and known to everyone without jeopardising the encryption security. Thus, a third party wanting to send an encrypted message reads the public key SGP corresponding to the desired contact, and encrypts their data series using this public key. Only the contact having the private key (S, G, P), in other words each of these three matrices independently of one another, can, using the inverse matrices of these matrices S, G and P, decrypt the message. If the public key is used on the server side, a leak of the algorithm of this server is not prejudicial, since this server does not have the matrices S, G and P but only the matrix SGP which cannot be used to restore the matrices S, G and P.

Lastly, one of the advantages now associated with the McEliece cryptosystem is its resistance to the future “quantum” attacks, as demonstrated by the “Classic McEliece candidate algorithm, based on this cryptosystem, during the “Post-Quantum Cryptography” competition organised by the “National Institute of Standards and Technology” (NIST) from 2016 to determine “quantum-resistant” public key algorithms.

### Cryptosystem According to a Preferred Embodiment of the Invention

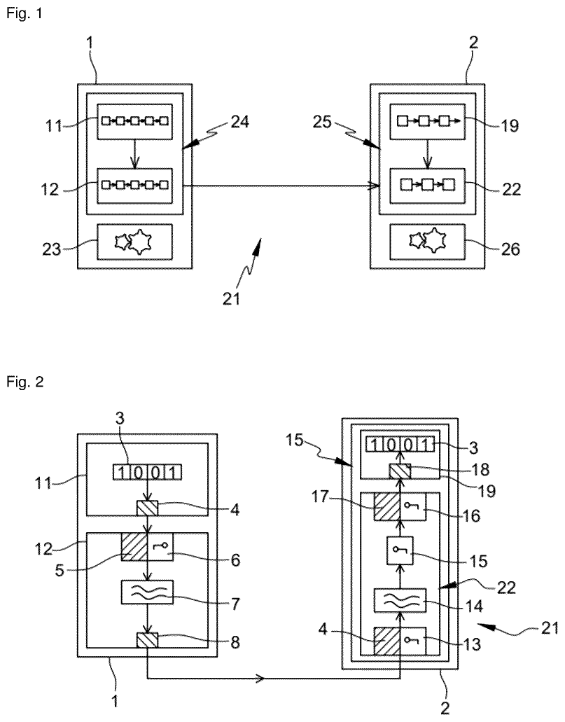

We will now describe the components of the cryptosystem according to a preferred embodiment of the invention. The elements forming this system are shown on FIG. 1, the operations carried out in this system on FIG. 2.

The cryptosystem 21 shown on FIGS. 1 and 2 includes a server 1 and a communication terminal 2, a smartphone in this case.

In this example, the server 1 is a bank server adapted to encrypt and communicate banking data such as the data series 3 of FIG. 2, but it could be another type of server. The server 1 includes conventional computer processing means 23 such as processors and memories. These computer processing means 23 are used to automate processing operations, in particular encryption operations. Thus, these means 23 are configured to automatically execute the steps of a computer program 24, stored in the server 1 as executable code. This program 24 is used to encrypt the data 3. The server 1 is itself divided, in terms of software, between a content server 11 and an encryption server 12, which use the same computer processing means 23. Thus, some of the code 24 can be executed on the server 11, some on the server 12, in order to encode data on the server 11, then encrypt these data on the server 12. The server 1 also includes conventional communication means, such as an Internet connection and communication programs, to send a series of encrypted data to the exterior, in particular to the terminal 2.

In a variant not shown, the device 11 and the device 12 are two physically separate computers which communicate using conventional means and use their respective processing means.

As will be seen below, and as shown on FIG. 2, the code 24 can be used to encrypt a data series 3 on the server 1, using the processing means 23. These encryption steps, executed by the processing means 23 according to the instructions of the code 24, concern, on the content server 11, an operation 4 for encoding the data 3. On the server 12, the executable code 24 requires a plurality of simultaneous operations on the series 3: an encoding 5 inversely to the encoding 4 and, simultaneously, the execution of permutations, coding and transformation using a key 6. The means 23 are then prompted by the code 24 to carry out an operation 7 of adding errors and an encoding operation 8 on the series 3, before sending the encrypted data 3 to the smartphone 2. All these operations, executed by the processing means 23 according to the instructions of the code 24, will be described in detail below.

The communication terminal 2 includes conventional computer processing means 26 such as processors and memories. These means 26 are used to automate processing operations, in particular decryption operations. Thus, these means 26 are configured to automatically execute the steps of a computer program 25, stored in the smartphone as an executable code. In terms of software, the executable code 25 is divided into two parts, a code corresponding to a decryption algorithm 22 and a code corresponding to a final application 19. The smartphone 2 also includes conventional communication means, such as an Internet connection and communication programs, to communicate to the exterior, for example to receive a series 3 of data encrypted by the server 1.

As will be seen below, and as shown on FIG. 2, the algorithm 22, executed by the means 26 according to the steps of the code 25, is the white box comprising cryptographic keys whose integrity must be protected. Thus, when it is executed by the means 26, this algorithm 22 carries out, on the data series 3 received in encrypted and encoded form, simultaneous encoding 9 and permutation operations using a private key 13. The encoding 9 corresponds to the inverse of the encoding 8, in other words to its decoding. The permutations of the key 13 correspond to the inverse of the permutations of the key 6. Note that the encoding 8, on the server 1 side, is therefore an encoding outside the white box 22, while the encoding 9 is the corresponding inverse encoding located in the white box. The white box 22, when it is executed by the processing means 26, also includes an error-correction operation 14 to correct the errors deliberately added to the data 3 by the error-addition operation 7. The algorithm 22 also comprises a decoding operation using a private key 15, the decoding by this key 15 concerning in this case the inverse of the coding by the key 6. This algorithm 22 also includes a last decryption operation using the private key 16, inverse to the transformation carried out by the key 6, and carried out at the same time as an encoding 17. Once again, we will describe these operations below, carried out on the smartphone 2 by the means 26.

The processing means 26 are also prompted by the executable code 24 to execute an application 19, which is a final payment application used by the holder of the smartphone 2. Thus, when the data 3 are decrypted and encoded by the processing means 26 according to the white box 22, the application code 19 instructs these means 26 to carry out an encoding operation 18, which consists of a decoding operation which is the inverse of the encoding operation 17, in order to decode the data. The encoding 18 is therefore an encoding outside the white box 22, corresponding inversely to the encoding 17 of the white box.

Once these operations have been carried out, the data 3 are therefore unencoded and decoded in the application 19 and can be used, in particular to make a bank payment, by the user of the smartphone 2.

Note that the application 19 is not sold to a user independently of the white box 22, these two software parts forming the executed code 25. The developer, or development company, of the final application 19 generally purchases the white box 22, sold as software libraries. The source code of the application 19 therefore comprises calls via an API (Application Programming Interface) to the algorithm 22 to control the execution of this algorithm. When the user downloads and installs their application, the latter therefore comprises the final application 19 and the corresponding white box 22, as a single code 25.

We will now describe some operations of this cryptosystem 21 that are shown on FIG. 2, referring regularly to the operations of the McEliece cryptosystem described above.

Firstly, an encoding matrix named J corresponds to the encoding 4. Thus, the data series 3 is encoded using the encoding matrix J in the encryption server 11.

The matrix J⁻¹, the inverse matrix of the matrix J, corresponds to the encoding 5, at the start of the encryption server 12.

The public key 6 is the matrix SGP as defined in the McEliece cryptosystem. However, in this cryptosystem 21, this matrix SGP is combined with the matrix J⁻¹ to form a merged matrix J⁻¹SGP. In other words, the matrix J⁻¹SGP is applied to the data 3 encoded by the matrix J at output of the content server 11, and it will therefore not only code and permute these data in accordance with the McEliece cryptosystem, but also decode the data according to the matrix J⁻¹, simultaneously. Note that, consequently, the public key 6 is masked in the server 11 by the encoding J⁻¹. In fact, the encoding of the matrix SGP by the matrix J⁻¹ makes any distinction between these matrices impossible for an attacker having the executable code implemented in the server 12. In addition, the encoding J masks the data between the content server 11 and the encryption server 12, while the encoding J⁻¹ is not accessible for an attacker since it is masked in the matrix J⁻¹SGP.

An encoding matrix which will be named F corresponds to the encoding 8.

The matrix F⁻¹, the inverse matrix of the matrix F, corresponds to the encoding 9, at white-box 22 input, on the terminal 2 side.

The matrix P⁻¹ as defined in the McEliece cryptosystem corresponds to the private key 13, matrix used to permute the data inversely with respect to the permutations of P and therefore of SGP. However, in this cryptosystem 21, this matrix P⁻¹ is combined with the matrix F⁻¹ to form a merged matrix F⁻¹P⁻¹. Thus, the matrix P⁻¹, and therefore the matrix P and generally the private key 13, is masked by the encoding 9 by using the matrix F⁻¹.

The matrix G⁻¹ as defined in the McEliece cryptosystem corresponds to the private key 15.

An encoding matrix which will be named H corresponds to the encoding 17.

The matrix S⁻¹ as defined in the McEliece cryptosystem corresponds to the private key 16. However, in the cryptosystem 21, this matrix S⁻¹ is combined with the matrix H to form a merged matrix S⁻¹H. Thus, the matrix S⁻¹, and therefore the matrix S and the private key 16, is masked by the encoding H.

Lastly, in the final application 19, the matrix H⁻¹ corresponds to the encoding 18.

It can be deduced that an attacker having the executable code can only identify the operations of the matrix G⁻¹, since this is the only matrix that is not masked. In other words, the private key 15 can be identified. However, the operations of the matrices P⁻¹ and S⁻¹, in other words the keys 13 and 16, are masked by respective encodings 9 and 17. In other words, this embodiment masks two out of the three private keys, while on the server side, an encoding 5 masks the public key 6.

In the remainder, we can speak indifferently of a key or its corresponding matrix. Similarly, we can speak indifferently of an encoding, of a decoding, and of their corresponding matrix.

We will now describe methods implementing the elements presented above.

### Generation of Keys and Combination with Encodings

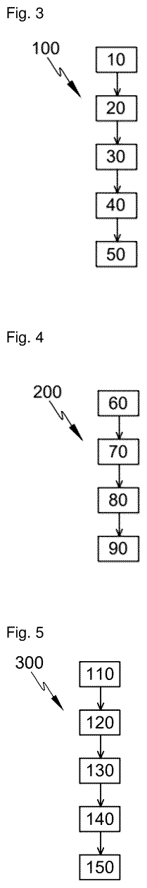

The method 100, shown on FIG. 3, is intended to install the cryptosystem 21 on the server 1 and the terminal 2. It is implemented by the computer processing means of the smartphone 2, of the server 1, even by independent means, located on a separate server. The location and the initialisation methods are not specific to the method described. We will therefore refer generally, to designate any computer processing means implementing this method, to “means” which carry out these operations automatically, wherever they are located.

In step 10, a user installs the payment application 19 on their smartphone 2. To protect the data 3 of the data series, the following steps are therefore implemented automatically.

In step 20, the means generate the matrices S, G and P. They are determined in accordance with the specifications of the McEliece cryptosystem. The means also compute their inverse matrices S⁻¹, G⁻¹ and P⁻¹. In other words, the private keys 13, 15 and 16 are generated.

In step 30, the means determine the matrix J and its inverse J⁻¹, the matrix F and its inverse F⁻¹, then the matrix H and its inverse H⁻¹. To do this, the matrices J, F and H are determined so as to be able to encode and decode accordingly any data series crossing the cryptosystem 21. Their terms are random, the only requirement being that these matrices can be inverted, so that the means generate the inverse matrices. In other words, the encodings 4, 5, 8, 9, 17 and 18 are generated.

In step 40, the means combine, in other words multiply together, some of the matrices generated. Thus, the matrices J⁻¹, S, G and P are combined to form the merged matrix J⁻¹SGP. The matrices F⁻¹ and P⁻¹ are combined to form the merged matrix F⁻¹P⁻¹. The matrices S⁻¹ and H are combined to form the matrix S⁻¹H.

In step 50, the matrices are placed at the specific locations of the cryptosystem 21.

Thus, the matrix J is placed on the content server 11 to form the encoding 4, the matrix J⁻¹SGP is placed at input of the encryption server 12 to form the simultaneous operation of encoding 5 and of permutation-coding-transformation by the public key 6. The matrix F is placed at output of the encryption server 12 to form the encoding 8. The matrix F⁻¹P⁻¹ is placed at white-box 22 input, on the terminal 2, to form the simultaneous operation of decoding 9 and of inverse permutation using the private key 13. The matrix G⁻¹ is placed in the white box 22, and forms the private key 15 used to decode the data. The matrix S⁻¹H, forming the private key 16 and the encoding 17, is placed at white-box 22 output to finish the decryption while encoding the data according to the encoding 17. Lastly, the matrix H⁻¹ is placed at input of final application 19 to decode the data.

The cryptosystem 21 is then ready. As a reminder, two private keys out of three, the keys 13 and 16, are masked therein and the public key 6 is also masked, using the encodings.

Concerning the use of resources, this key generation method is more costly than that of McEliece since more matrices are generated and combined. However, the four matrices J, F H and S correspond to linear transformations, so it is sufficient to generate these four matrices randomly, the sole condition being that they can be inverted. No other complex computation is required.

### Encryption Method

We will now describe a method 200 for encrypting the data series 3, carried out on the server 1, referring to FIG. 2 and FIG. 4. It is implemented when use of the final application 19 requires the server 1 to send encrypted data, in this case banking data to make a payment.

In step 60, first step of this encryption method, the data series 3 is encoded on the content server 11 by the encoding 4, in other words in concrete terms using the encoding matrix J. The data series 3 is therefore now encoded. The presence of this encoding 4 divides the server 1 into two: a content server 11 and an encryption server 12. Thus, if an attacker tries to intercept the data before they are encrypted on the encryption server 12, the attacker only obtains encoded data, that cannot be decoded without having J or J⁻¹. However, J is located on the content server 11 side, and J⁻¹ is masked in the matrix J⁻¹SGP.

In step 70, the matrix J⁻¹SGP is applied to the encoded data series 3, in other words this series, forming a vector, is multiplied by the matrix J⁻¹SGP. The operation results in a data series 3 decoded with respect to the encoding 4, due to the operations of J⁻¹ masked in this matrix, but also and simultaneously transformed by S, coded by G and with data permuted by P.

In step 80, the error-addition module 7 adds one or more errors to the transformed, coded data series 3 with permuted data. The data series is therefore now transformed, coded, and with permuted data, and “deliberately incorrect”: it is therefore encrypted in accordance with the McEliece cryptosystem.

In step 90, this encrypted data series 3 is encoded by the encoding 8 using the encoding matrix F. The data series 3 is therefore encrypted and encoded.

The server 1 then sends this encrypted data series to the terminal 2.

Concerning the use of resources, this method is more costly than that of McEliece since the encoding 8 is added at end of server. However, adding the encoding 5 has no impact since it is combined with the public key 6. In addition, since this method is carried out on server, the latter can easily be designed accordingly.

### Decryption Method

We will now describe a decryption method 300 referring to FIGS. 2 and 5. It is carried out on the smartphone 2, in the white box 22, and targets the data 3 received in encrypted and encoded form.

In step 110, the decoding 9 and the private key 13 simultaneously decode and permute the data of the data series 3, the decoding operations being carried out by the operations of the matrix F⁻¹, the permutation operations being carried out by the matrix P⁻¹, all these operations being carried out simultaneously by the matrix F⁻¹P⁻¹ applied to the data series 3. The data series 3 is therefore decoded and permuted in order to restore its original structure. It remains “deliberately incorrect”, coded and transformed. An attacker reading the executable code of this operation would be unable to distinguish between F⁻¹ and P⁻¹. In addition, since the encoding F is located only on the server, there is no access to the white box 22 and the attacker would be unable to find P⁻¹ from the matrix F⁻¹P⁻¹. The attacker would therefore be unable to identify the private key 13 formed by the matrix P⁻¹. The private key 13 is therefore masked by the encoding 9.

In step 120, the error-correction module 14 identifies and removes the errors from the data series 3. Any correction algorithm can be implemented to do this. This fast correction is made possible due to the fact that the original structure of the data series has been restored after the inverse permutation operations of P⁻¹ masked in F⁻¹P⁻¹. The data series therefore now remains only coded and transformed according to the operations of the matrix G and S by J⁻¹SGP.

In step 130, the private key 15 is used in the form of the matrix G⁻¹, to decode the data series so that the coding operations of G masked in the matrix J⁻¹SGP are inverted. The data series therefore now remains only transformed by the operations of S in J⁻¹SGP.

Lastly, in step 140, this data series is simultaneously transformed by S⁻¹, forming the private key 16, and encoded by H, forming the encoding 17, in the matrix S⁻¹H. The masked operations of S⁻¹ therefore finish decrypting the data series in accordance with the McEliece cryptosystem, while H encodes these data. The encoding H performs two functions. It is used to mask the operations of S⁻¹, so that an attacker accessing this matrix S⁻¹H cannot identify S⁻¹. The private key 16 is therefore masked by the encoding 17. In addition, this encoding H prevents the data series 3 from circulating unencoded between the white box 22 and the final payment application 19. Thus, an attacker trying to intercept the data at the output of the white box would be unable to identify the data or the key 16.

In step 150, the inverse encoding 18 is implemented on the final application 19 to decode the data.

The final application 19 can then use the data to make the requested banking payment, for example.

Concerning the use of resources, this decryption method is not more costly than that of McEliece, which is highly advantageous since it is implemented on a mobile terminal. In fact, the encodings 9 and 17 are used at the same time as the keys 13 and 16.

Obviously, the encryption and decryption methods can be switched, decryption taking place on the server, encryption on the server 2, provided that the encodings initially placed on the server are now placed on the terminal 2, and those of the terminal 2 are placed on the server. The method then remains the same.

### Other Technical Effects

The invention therefore takes advantage of the combination between the operations defined in the McEliece cryptosystem and the encodings of these operations to protect the integrity of the white-box 22 encryption.

In particular, the user's private keys, stored on the white box 22, are protected even in case of a leak of the algorithm located on the server 11. In fact, even if the matrix J⁻¹SGP is identified by an attacker, the latter cannot deduce the matrices S, G and P and therefore their inverse matrices used to decrypt the data on the smartphone 2. This is still the case even if J⁻¹ is identified.

In addition, on the white box 22, the private keys 13 and 16, formed by the matrices P⁻¹ and S⁻¹ are masked respectively by the matrices F⁻¹ and H of the encodings 9 and 13. An attacker having the executable code of the white box 22 is therefore unable to identify the keys 13 and 16.

The cryptosystem 21 therefore specifically protects the integrity of the white-box encryption.

In addition, note also that the external encodings 8 (matrix F) and 18 (matrix H⁻¹), located respectively on the server 11 and the final application 19, make any porting of code of the white box 22 ineffective, since these encodings are required to identify the encoding 9 (matrix F⁻¹) masking the key 13 (matrix P⁻¹) and the encoding 17 (matrix H) masking the key 16 (matrix S).

Lastly, as mentioned above, the encodings 4 and 5, associated with the matrix J, divide the server 1 into two separate servers: a content server 11 and an encryption server 12, to thus encode the data before they are encrypted. This also masks the operations of SGP, due to the matrix J⁻¹SGP. Consequently, if the algorithm of the encryption server 12 leaks, the encoding 5 continues to mask the key 6, while if the content server 11 is attacked, the data and the encoding 4 can still not be identified.

In addition, the operations of the matrices G and P in accordance with the McEliece cryptosystem, in the matrix SGP and therefore in this case the matrix J⁻¹SGP, provide resistance to the future quantum attacks, which is retained in this case, the encodings do not modify these operations but are intended to mask them. The cryptosystem 21 therefore protects the integrity of the white-box encryption while making this white box resistant to the future quantum attacks.

Lastly, generally, the cryptosystem 21 associates three encoding pairs with the McEliece cryptosystem: the encodings 4 and 5, the encodings 8 and 9, and the encodings 17 and 18. The place of these encodings in the cryptosystem 21 makes the latter resistant even in the event of a leak of one of these pairs, for any attacker having the entire executable code. In fact, in the event of a leak of the pair of encodings 4 and 5, in other words if an attacker succeeds in identifying the operations of the matrix J and therefore of the matrix J⁻¹ on the server, the attacker can deduce from the matrix J⁻¹SGP the operations of a matrix SGP. Thus, the public key in accordance with the McEliece cryptosystem is unmasked. However, even by having access to this matrix SGP and to the matrix G intelligible in unencoded form in the white box 22, this attacker cannot identify the operations of the matrices S and P. The private keys 13 and 16 therefore remain secret. Alternatively, in the event of a leak of the pair of encodings 8 and 9, in other words if the attacker succeeds in identifying the operations of the matrix F (and its inverse), they can deduce the operations of the matrix P by accessing the matrix F⁻¹P⁻¹ on the white box 22. The attacker therefore deduces the key 13. However, they cannot deduce the operations of the matrix S, therefore of the key 16. Lastly, alternatively, in the event of a leak of the encodings 17 or 18, therefore of the matrix H, the key 16 is identified using the matrix S⁻¹H. However, the key 13, in other words the matrix P, can still not be identified. Thus, in these three cases, a leak of one of the three pairs of encodings does not allow the attacker to access all the secret keys formed by the matrices S, G and P and their inverse matrices.

Consequently, the following three variants can be considered.

Thus, in a variant not shown, the encodings 4 and 5 do not exist. The server 1 is unified. Since the matrix J does not exist, the data to be encrypted are multiplied directly by SGP. All the advantages described above remain valid, except those associated with the encodings 4 and 5. In this case therefore, the public key 6 is not masked, but the secret keys 13 and 16 remain preserved.

In another variant, the encodings 8 and 9 do not exist. This time, the public key 6 therefore remains masked by the encoding 5, but the key 13 can be identified by an attacker having the white box 22. The key 16 remains secret, however.

Lastly, in the third variant, the encodings 17 and 18 do not exist, so in this case the key 16 can be identified, but the public key and the private key 13 remain secret.

In a fourth variant not shown, instead of deleting a pair of encodings and therefore enabling an attacker to identify one of the keys, a pair of encodings is added to mask the secret key 15 in the white box 22. In particular, an encoding matrix K can be combined with the matrix G⁻¹ to form a matrix G⁻¹K, then the matrix K⁻¹ can be combined with the matrix S⁻¹H to form a matrix S⁻¹HK⁻¹. With this variant, each key is masked, and an attacker now needs to identify not only two but three pairs of encodings to identify each of the secret keys. The encryption security is therefore increased accordingly, at the expense of additional resources when generating the keys and the associated encodings.

The invention is not limited to the embodiments described and other embodiments will be clearly apparent to those skilled in the art. In particular, the encoding matrices can be replaced by any form of encoding, for example substitution tables replacing truth tables in the executable code.

1. A method for generating a cryptographic key, executed by computer processing means, wherein the following steps are carried out:
generating a permutation matrix (P), a coding matrix (G) and a linear transformation matrix (S), the three matrices being in accordance with a McEliece cryptosystem;
generating an inverse permutation cancellation matrix (P⁻¹) of the permutation matrix (P), an inverse coding cancellation matrix (G⁻¹) of the coding matrix (G), and an inverse transformation cancellation matrix (S⁻¹) of the linear transformation matrix (S), the three cancellation matrices (S⁻¹, G⁻¹, P⁻¹) being in accordance with the McEliece cryptosystem;
combining the permutation matrix (P) with the coding matrix (G) and with the linear transformation matrix (S), to form a merged permutation, coding and transformation matrix (SGP) in accordance with the McEliece cryptosystem, characterised in that the computer processing means execute a step of generating at least two random encoding matrices (J⁻¹, F⁻¹, H), the computer processing means executing at least two of the following three combinations steps:
combining one of the random encoding matrices (J⁻¹) with the merged permutation, coding and transformation matrix (SGP), to form an encoded permutation, coding and transformation matrix (J⁻¹SGP),
combining another one of the random encoding matrices (F⁻¹) with the permutation cancellation matrix (P⁻¹) to form an encoded permutation cancellation matrix (F⁻¹P⁻¹),
combining another one of the random encoding matrices (H) with the transformation cancellation matrix (S⁻¹) to form an encoded transformation cancellation matrix (S⁻¹H).

2. The method according to claim 1, wherein the computer processing means execute the three combination steps.

3. The method according to claim 2, wherein, for each random encoding matrix generated (J⁻¹, F⁻¹, H), the processing means execute a step of determining a corresponding inverse encoding matrix (J, F, H⁻¹) of said random encoding matrix, so that a data series encoded by said random encoding matrix (J⁻¹, F⁻¹, H) is decoded by the corresponding inverse encoding matrix (J, F, H⁻¹), and vice versa.

4. The method according to claim 1, wherein the computer processing means further execute at least two out of the following three integration steps:
integrating, in an application for encryption server, the encoded permutation, coding and transformation matrix (J⁻¹SGP);
integrating, in an application for decryption terminal, the encoded permutation cancellation matrix (F⁻¹P⁻¹);
integrating, in the application for terminal, the encoded transformation cancellation matrix (S⁻¹H).

5. The method according to claim 3,
wherein the computer processing means further execute at least two out of the following three integration steps:
integrating, in an application for encryption server, the encoded permutation, coding and transformation matrix (J−1SGP);
integrating, in an application for decryption terminal, the encoded permutation cancellation matrix (F−1P−1);
integrating, in the application for terminal, the encoded transformation cancellation matrix (S−1H), and
wherein the means further execute at least two out of the following three integration steps:
integrating, in an application for content server, the corresponding inverse encoding matrix (J) of the encoding matrix (J⁻¹) that has been combined with the merged permutation, coding and transformation matrix (SGP), so that a data series encoded by this inverse encoding matrix (J) on a content server is decoded by the encoded permutation, coding and transformation matrix (J⁻¹SGP) on an encryption server;
integrating, in the application for terminal, the corresponding inverse encoding matrix (F) of the encoding matrix (F⁻¹) that has been combined with the permutation cancellation matrix (P⁻¹), so that a data series encoded by this inverse encoding matrix (F) on the encryption server is decoded by the encoded permutation cancellation matrix (F⁻¹P⁻¹) on a decryption terminal;
integrating, in the application for terminal, the corresponding inverse encoding matrix (H⁻¹) of the encoding matrix (H) that has been combined with the transformation cancellation matrix (S⁻¹), so that a data series encoded by the encoded transformation cancellation matrix (S⁻¹H) is decoded by the inverse encoding matrix (H⁻¹).

6. A data encryption method, characterised in that, to encrypt a data series, computer processing means execute the following steps:
after a merged transformation, coding and permutation matrix (SGP), in accordance with a McEliece cryptosystem, has been combined with an encoding matrix (J⁻¹) to form an encoded coding, permutation and transformation matrix (J⁻¹SGP), applying the encoded coding, permutation and transformation matrix (J⁻¹SGP) to the data series, in order to form a coded, permuted and transformed data series;
deliberately adding one or more errors, in accordance with the McEliece cryptosystem, to the coded permuted and transformed data series, in order to form an encrypted data series.

7. The method, according to claim 6, wherein, beforehand, the computer processing means apply to the data series a preliminary inverse encoding matrix (J) of the encoding matrix (J⁻¹) to form an encoded data series, so that the encoded data series is then decoded by the encoded coding, permutation and transformation matrix (J⁻¹SGP) at a same time as it is coded, permuted and transformed by this encoded coding and permutation matrix.

8. The method according to claim 6, wherein, in addition, the computer processing means further execute a step of applying a second encoding matrix (F) to the encrypted data series, to form an encrypted and encoded data series.

9. A data decryption method, characterised in that, to decrypt an encrypted data series, a permutation cancellation matrix (P⁻¹), in accordance with a McEliece cryptosystem, having been combined with an inverse encoding cancellation matrix (F⁻¹) of an encoding matrix (F), previously applied during an encryption operation, to form an encoded permutation cancellation matrix (F⁻¹P⁻¹), a processing means execute a step of applying to the encrypted data series the encoded permutation cancellation matrix (F⁻¹P⁻¹) to form a restructured data series with cancelled encoding.

10. The method according to claim 9, wherein the means execute a step of removing errors, in accordance with the McEliece cryptosystem, from the restructured data series with cancelled encoding, in order to form a corrected, restructured data series with cancelled encoding.

11. The method according to claim 9, wherein the means execute the following steps:
applying a decoding matrix (G⁻¹), in accordance with the McEliece cryptosystem aimed at decoding data previously coded during an encryption operation, to the corrected, restructured data series with cancelled encoding, in order to form a corrected and decoded restructured data series with cancelled encoding;
a transformation cancellation matrix (S⁻¹), in accordance with a McEliece cryptosystem, having been combined with an encoding matrix (H) to form an encoded transformation cancellation matrix (S⁻¹H), applying to the corrected and decoded restructured data series, with cancelled encoding, the encoded transformation cancellation matrix, to form a decrypted and encoded data series.

12. The method according to claim 11, wherein the means execute a step of applying, to the decrypted and encoded data series, an encoding cancellation matrix (H⁻¹), inverse of the encoding matrix (H) used to form the encoded transformation cancellation matrix (S⁻¹H), in order to form a decrypted data series.

13. A computer program, comprising instructions which, when the program is executed by a computer, instruct the computer to implement the steps of the method according to claim 1.

14. A non-transitory computer-readable storage medium, comprising instructions which, when they are executed by a computer, instruct the computer to implement the steps of the method according to claim 1.

15. A cryptographic key generation server, comprising the computer processing means adapted to execute the method according to claim 1.

16. An encryption server, comprising the computer processing means adapted to execute the method according to claim 6 to encrypt the data series.

17. A communication terminal, comprising computer processing means adapted to execute the method according to claim 9 to decrypt a data series.

18. A cryptosystem comprising at least one cryptogrpahic key generation server comprising the computer processing means adapted to execute the method according to claim 1, and at least one communication terminal, the at least one communication terminal comprising computer processing means adapted to execute a data decryption method to decrypt a data series, characterised in that, to decrypt an encrypted data series, a permutation cancellation matrix (P⁻¹), in accordance with a McEliece cryptosystem, having been combined with an inverse encoding cancellation matrix (F⁻¹) of an encoding matrix (F), previously applied during an encryption operation, to form an encoded permutation cancellation matrix (F⁻¹P⁻¹), a processing means execute a step of applying to the encrypted data series the encoded permutation cancellation matrix (F⁻¹P⁻¹) to form a restructured data series with cancelled encoding.
